(19) United States
(12) Patent Application Publication
(10) Pub. No.: US 2005/0183061 A1
(43) Pub. Date: Aug. 18, 2005

(54) Arrangement and a method relating to access of applications/services

(76) Inventors: Thomas Papanikolaou, Dusseldorf (DE); Jan Akerfeldt, Taby (SE); Oliver Hulla, Herzogenrath (DE); Fredrik Tarberg, Stockholm (SE)

Correspondence Address: ERICSSON INC., 6300 LEGACY DRIVE, M/S EVR C11, PLANO, TX, 75024, US

(21) Appl. No.: 10/470,224

(22) PCT Filed: Jan. 24, 2002
(86) PCT No.: PCT/SE02/00127

(30) Foreign Application Priority Data
Jan. 24, 2001 (SE) 0100191

(51) Int. Cl. G06F 9/44

(52) U.S. Cl. 717/103

(57) ABSTRACT

The present invention relates to a portal structure for providing end user stations (5) with access to services/applications. It comprises a portal core (1) a connectivity layer via which end user station access is provided and a number of services/applications (25).

The services/applications (25) are represented in a generic markup language and the portal core (1) uses said generic markup language for storing at least application/service data information and for communication with said services/applications. It further comprises a presentation arrangement (11) for communication with said applications/services (25) and said end user stations (5). Each service/aaplication (25) represented by generic data in the generic markup language may optionally be provided with a number of metalink tags, such that each service/application (25) is able to generate generic link data in the generic markup language irrespectively of the location of the portal structure and of other applications. The portal core presentation arrangement (11) comprises first translating means (16) for replacing such metalinks with real (public) addresses of the services/applications (25), such that continuous navigation is enabled for end users irrespectively of the location of accessed services/applications (25).

### TECHNICAL FIELD

The present invention relates to a portal structure for providing end user stations with access to services/applications. Particularly it relates to an Internet portal, and specifically it relates to a portal structure providing an end user with improved navigation support. Most particularly it relates to a portal structure facilitating access to applications/services irrespectively of the location of such services and irrespectively of which is the type of the end user station.

### STATE OF THE ART

Continuous navigation in a portal relates to the ability to view information and associations binding such information together. In some cases the information and the associated resources (application contents and service contents) reside within the portal itself. However it is also often the case that the information resides with third party content providers, which then themselves provide, and are responsible for, an infrastructure managing such information and for publishing it towards the portal. In that case the portal must support the ability to connect to external infrastructures and to provide appropriate navigation facilities also to such services/applications not residing within the portal itself. By within the portal is meant that the service/application/content providers are internal providers.

When referring to a portal is generally meant an Internet portal. There is also an increasing need to personalize or customize the way an end user can access services irrespectively of the actual location of the services or applications. At the same time the demand for access to mobile Internet services gains importance, i.e. the end users need to be able to, in a rapid and uncomplicated manner, get access to services from any end user station, i.e. also from mobile devices; it may e.g. relate to sending and a receiving e-mails, short messages and accessing web-based information from mobile as well as fixed end user devices in a user friendly, quick and simple manner. This is called the mobile Internet.

Browsing using the mobile device is however more difficult than browsing using a PC, since the mobile device, as compared to the PC, has limited input and output capabilities. This means that it gets even more difficult to provide mobile end users with a satisfactory personalization and management of services. Generally there is an increasing demand on behalf of the end users to always be able to access applications and services. A portal is such a doorway to the content of services and applications, which particularly should be tailored to suit the end user preferences.

Examples of portal content are information services (also including push content, which relates to an Internet technique through which all information a user subscribes to, or information that the service provider or operator means that the user should be provided with, automatically is provided to the user). Examples on information services are weather forecasts, or weather information in general, commercial services such as shopping malls, or generally any kind of information, multimedia services such as streaming audio/video, games, instant messaging and newsgroups, web based mail, access to particular communities through chat-rooms. It is also highly desirable to be able to provide appealing graphical user interfaces for representing applications and menus on PC:s, and particularly also for WAP-enabled devices, in case a portal is mobile. Much effort is put down on personalizing the structure and the content of personal portals, and to provide a possibility to control the interaction and behaviour of individual services and applications by setting personal preferences. It has however turned out to be difficult to provide for satisfactory navigation properties as well as satisfactory access possibilities irrespectively of which kind of device that is used by an end user.

A portal core is here defined as the central part of the portal structure that is needed to develop a portal framework within which content and applications can be disclosed and accessed by end users in a controlled and unified manner.

Until now many applications are in principle exclusively designed for the 2G telecommunications environment and they have been implemented as monolithical blocks or with a proprietary service network to handle the specific QoS requirements for the respective applications. This has a consequence that such applications work satisfactorily as isolated applications, but they are difficult to integrate with other applications developed in similar ways. Applications developed for the Internet (Internet protocol) environment have to a large extent been based on established and open de facto standards supporting extensive integration of different applications. Many such standards have been used in the 2G environment for non real-time critical applications. However, through the introduction of 3G networks (3GPP), future applications will contain a mixture of telecommunication and datacommunication services, mixing higher and lower bit rates, as well as real time and non-real time traffic. The service networks of today are not designed to handle such mixtures and the existing IP-based applications are also not designed for the specific characteristics associated with wireless networks. As can be seen there are many factors complicating the provision of satisfactory access for end users to services and there are no straightforward solutions and satisfactory solutions to the problems associated with the provision of seamless navigation in a portal for end users.

WO 00/49519 discloses a solution with a storage scheme where conversions are applied to content, the content being unaware of the specific conversions applied. However, the storage scheme is static. Hence the transformation to be applied to the specific content is fixed (not user or device specific). It is not possible to dynamically decide on the (set of) conversions to be applied on specific content. In order to be able to serve a plurality of heterogeneous client devices would require a huge directory structure and a proliferation of redundant content copies, each copy in a different directory. Thus, the described solution suffer from apparent disadvantages and drawbacks.

### SUMMARY OF THE INVENTION

By using a generic markup language in a portal, content of applications and services can be stored independently of end user station or user device, and before showing the content of an application or a service, the content can be transformed into the format, i.e. the markup language, that can be understood by the end user device. One example of such a generic markup language is the XML (Extended Markup Language). As a standard for navigation in an XML-based portal is the XLink specification used, which allows elements to be inserted into XML documents in order to create and describe links between resources. XLink provides a framework for creating both basic unidirectional links and more complex linking structures. It allows XML documents to assert linking relationships among more than two resources, associate metadata with a link and to express links residing in a location separate from the linked resources. However, continuous navigation between portals and particularly external content providers can not be achieved through simply using XML and XLink.

What is needed is therefore generally a portal structure providing an end user with fast and easy access to services and applications irrespectively of whether the services and applications (content) are located within the portal structure itself or whether the applications/services and the content thereof reside outside the portal (i.e. are provided by external providers). Particularly a portal structure is needed which is capable of providing an end user with quick and simple access to content of applications and services, also if the wanted services/applications require special access rights, or more generally a portal structure supporting handling of dynamic issues, like access control etc.

A portal structure is also needed through which service/application providers are able to provide the same navigation features in the content they supply as the portal structure itself does, i.e. as it does for applications/services residing within the portal. A portal structure is also needed which is able to provide a common “look and feel” irrespectively of where applications/services reside or by whom they are provided. Particularly a portal structure is also needed which is capable of storing content independently of user access device or user station, and supporting transformation of content of applications and services to the format of the user device or a format that the user device (i.e. the end user station) is able to understand. Even more particularly a portal structure is needed through which the number of parameters that have to be sent to applications/services (content providers) from the browser of an end user is reduced as compared to hitherto known structures.

Particularly a portal structure is needed which allows for connection of a large number of internal as well as external service and application providers, or content providers, while still providing the same navigation features to external providers as to internal providers without requiring an extension or additional programming of the portal implementation. Even more particularly a portal structure is needed which is mobile, i.e. which allows access by mobile end user stations, and specifically a portal structure is needed which allows mobile station as well as fixed station access. Still further a portal structure is needed which is end user friendly and easy to use and which allows user personalization or customization such as to suit the specific needs and preferences of different end users. Particularly a portal structure is needed which in an attractive way integrates Internet and WAP (Wireless Application Protocol) based services so that access is enabled from any Internet connected PC, WAP-device or any other mobile device using various mobile access networks such as for example GSM (Global System for Mobile communications), GPRS (GSM General Packet Radio Service), WCDMA (Wideband Code Division Multiple Access), UMTS (Universal Mobile Telecommunications), SMS (Short Message Service), broadband also allowing access by PDAs (Personal Digital Assistant), i.e. technology independent access.

In the following some further concepts used herein will be described or defined. A portal is generally a non-physical entity in the Internet domain, which can be described as an “electronic publishing space” which is owned by an individual or an organization, and which provides either direct access to information and services, or links to other entities in the Internet or private intranet domains, providing information and services to authorized end users. A portal is in its simplest form a regular home page or list of links, whereas in more advanced forms it may offer interactive services not only to those who consume what is published, but also to those who are granted the right by the editor to publish on the portal, as well as to the editor himself, regarding different aspects on how the portal is used.

Wireless end users are given access through a “service” portal. Such a “service” portal is different from a traditional fixed Internet portal for PCs and end users demand personalized services delivered to and presented on their mobile terminal at least as an option. In this document the concept portal (structure) is used. It can be both a conventional Internet portal or a “service” portal, a mobile portal.

An application is one or several cooperating software entities, the functional focus being user interaction and usefulness for the end user. An application platform is a defined combination of software and hardware entities used to implement applications of a certain kind, which are characterized by the functionality and quality of its constituent parts.

By portal infrastructure is, in general terms, meant the software and hardware entities needed to either host or produce or generate a specific portal. Specifically it contains a portal core, an IP infrastructure and service enabling means.

A service enabling means, here also denoted a service enabler, is a support functionality accessed via APIs (Application Programming Interface) raising the abstraction level and simplifying the application developers task. The portal core, as referred to above, is the core of a portal infrastructure. By a service network is generally meant an IP-based network which consists of nodes hosting application servers, service capability servers, application support servers, IP infrastructure servers etc. Application support servers interface with service network resources or other external resources than core networks, whereas service capability servers interface with resources and functionality in core networks. In the present application a portal structure is intended to mean a portal core, a plurality of services and applications with their content and service enabling means (service enablers). Generally may also the connectivity and data bearer functionality be seen as included.

Therefore, in order to solve one or more of the problems referred to earlier in the document, the invention discloses a portal structure, for providing end user stations with access to services/applications, i.e. the content of services and/or applications. It comprises a portal core, a number of service enabling means, connectivity means acting as data bearer and via which end user station access is provided, and services/applications (providers). The services/applications use or generate a generic markup language to represent a content, the portal core uses said generic markup language for storing application/service data information and for communication with said services/applications. The portal core also comprises a presentation arrangement for communication with the applications/services and with said end user stations. Each service/application as represented by generic data in the generic markup language may be provided with one or more metalink tags referring to other services, applications or content (internal or external) such that each service/application is able to generate generic link data by means of the generic markup language irrespectively of the location of the portal core and of other applications/services. The portal core presentation arrangement comprises first translating means for replacing such metalinks with real (public addresses) of the services/applications content referred to, such that continuous navigation is enabled for end users irrespectively of the location of services/applications (content).

The portal core presentation arrangement particularly comprises rendering means which includes said first translating means. Alternatively the rendering means are provided separately in the portal core and only comprises second translating means for translating (rendering) service/application data presented in the generic markup language into a format, or a markup language, as understood or used by the end user station having requested a service or an application.

A portal core further comprises session handling means for user session management. Particularly service logic is kept separate from presentation related logic. Said session handling means are also separate from the rendering means.

According to the invention a number of different types of metalinks can be defined such that an application or a service can be provided with the appropriate kind(s) of metalink(s) depending on where the content to be referred to resides. In one embodiment four different kinds of metalinks are defined, although the inventive concept of course not is limited to the definition of four different kinds of metalinks or to the specifically exemplified metalink types. However, according to one embodiment the first metalink, which may be denoted a metalink of type “self” is defined which refers to the service/application that itself has generated the data as represented by the generic markup language. A second metalink type “local” may also be defined which refers to resources which are local to the service/application. It includes information about the path to the resource in relation to the service/application. A third metalink type “absolute” is defined which comprises a link to any public or private portal, WEB-page, resource, application or content and it contains a reference with the complete URL (Uniform Resource Locator) to such resource, content etc. Finally a fourth metalink type denoted “application” is defined, according to this embodiment, which refers to an application defined in the portal structure under a given name and it contains information about said name.

Particularly data representing services/applications as expressed in the generic markup language and metalinks are defined in a Document Type Definition (DTD) language with an URL-attribute. DTD is e.g. an XML document describing all the elements and their attributes which are allowed in all the documents belonging to the particular DTD.

In a most advantageous embodiment the portal structure is mobile, i.e. it supports access by mobile end user stations over a mobile communication network such as for example GSM (Global System for Mobile communications), GPRS (GSM General Packet Radio Service), UMTS (Universal Mobile Telecommunications System), Bluetooth (which is a short range radio technology), WAP (Wireless Application Protocol) etc. Advantageously the portal structure supports access by broadband devices such as PCs or more generally fixed devices as well as mobile devices such as WAP-devices.

In other terms the portal structure supports access by fixed as well as mobile end users stations using different access formats or using different markup languages for communication with the portal structure. Detection of the type of a requesting end user station may be done in any appropriate manner. However, it may with advantage be performed as disclosed in the copending Swedish patent application “An Arrangement and a Method Relating to End User Station Access of a Portal” which was filed on the same date as the present application, by the same applicant, and the content of which herewith is incorporated herein by reference. In that application it is disclosed how an end user station can get access to the portal structure itself, also if the type of the end user station is not known to the portal structure, as long as the class to which the type belongs is known to the portal, which adaptively will get to know new types, i.e. it is generally adaptive to new types.

According to one particular embodiment a service or an application may optionally be provided with one or more metainformation tags. The rendering means adds the parameters of such a metainformation tag to all metalink parameters at least for some types of metalinks. Particularly the metainformation tags can optionally be added to “self” or “application” type referring metalinks and all parameters common to all the links of an application are stored in the portal core per end user and per application instance. All parameters common to all the links in the application will then be defined in one place and can be stored by the portal. The stored parameters can then be sent to the application when the end user accesses the application next time (in the same session). The parameters will, as referred to above, be stored per end user and per application instance which means that different application instances can have different global parameters. The advantage thereof is that the addresses (URLs), of applications that need to be sent to the end user, get much shorter. This is particularly attractive in case the end user accesses the portal using a mobile end user station, i.e. a WAP-device. Only parameters that differ in different links will have to be sent to the end user station, i.e. when different links within one and the same application or service have different parameters.

It is also possible to add such metainformation tags to other links than metalinks, e.g. XLinks. The functioning will be the same as that described above referring to metalinks. Thus, addition of metainformation tags to some kind of links is generally advantageous also in case the concept of metalinks is not implemented, e.g. since shorter URLs can be used to e.g. a mobile end user station.

Although the invention is not limited thereto, in a particularly advantageous implementation, the generic markup language used by or generated by the services/applications and the portal core, particularly the presentation arrangement of the portal core, is XML. The XML-data and the metalinks are defined in a Document Type Definition language (DTD) and a metalink tag in XML-data comprises information about metalink type, a reference and addressing attribute (URL) containing service/application location information. The second translating means (of the rendering means) translates XML-data by performing a transformation (XSL), i.e. the XML-data is processed with a transformation stylesheet (XSL transformation) to produce an output format, i.e. a markup language, appropriate for the accessing end user station, e.g. HTML for a fixed end user station and WML for a mobile end user station.

XML is e.g. described in Extensible Markup Language (XML) 1.0 (Second edition), W3C Recommendation 6 Oct. 2000. XSL/XSLT is described in XSL Transformations (XSLT) Version 1.0 W3C Recommendation of 16 Nov. 1999 and XSL Transformations (XSLT) Vers. 1.1., W3C Working draft, 12 Dec. 2000. These documents are herewith incorporated herein by reference.

A portal structure is particularly disclosed which provides end user stations with access to applications/services. The portal structure comprises a portal core, a number of service enabling means, a connectivity and data bearer layer via which end user access is provided and a number of services/applications (providers). The portal core is typically XML-based and uses XML as a markup language for storing data as XML-data and for communication with services/applications. The portal core further comprises means for presentation on end user stations. The services/applications are represented by XML-data in the portal core and each service/application in XML-data may be provided with/generate one or more metalink tag(s) such that each service/application is able to generate XML link data independently of which is the location of the portal core and of the services/applications. The portal core further comprises first translating means for replacing metalinks with real addresses of the services/applications (content) referred to. The portal structure is, according to an advantageous implementation, mobile and supports end user access by mobile as well as fixed end user stations, e.g. WAP-devices and broadband devices such as PC:s, (or rather the used browser) interactive TV etc.

A portal structure for providing end user access to services/applications is provided which comprises a functional services/applications layer, a user access layer and an intermediate communication layer for communication with services/applications and with the end user via the access layer. The intermediate communication layer comprises a presentation arrangement with rendering means and session handling means receiving requests for services/applications by end user stations, forwarding said requests for services/applications by end user stations to the service/application layer, receiving XML-data information representative of the requested services/applications, and comprising means for converting such XML-data information representative of requested services/applications to a format usable by the requesting end user station. The services/applications may be provided with metalink tag(s) and said presentation arrangement comprises translating means for replacing metalinks with corresponding real address information of the service(s)/application(s) referred to by the metalink(s). Instead of XML any other generic markup language with similar properties may be used.

The invention also discloses a method for providing end user stations with access to services/applications via a portal structure comprising a portal core, services/applications and end user connectivity means, which method particularly includes the steps of; receiving in the portal core a request for a service/application from an end user station in an end user station markup language; forwarding the request to the requested service/application; receiving data relating to the requested service/application as represented by a generic markup language which may include one or more metalink tags referring to (other) applications/services/content in the portal core from the service/application; translating the metalink tag(s) to real addresses of the application(s)/service(s) referred to in the portal core; providing the data of a requested service/application to the end user station in a format (markup language) appropriate for the end user station.

The portal core particularly comprises rendering means which perform the steps of; detecting if data of a service/application in the generic markup language contains one or more metalinks; if yes, processing said metalink(s) and replacing it/them with (a) real address(es) of the service(s)/application(s) referred to. Particularly the method includes the steps of; providing a service/application with a metalink of a given type depending on where the requested content of a service/application referring to is located.

The method may comprise the steps of; providing an application/service with a metalink tag referring to the application itself if the content of the application/service referring to is provided by the application/service itself; providing a service/application with a metalink tag referring to local content if the content referring to is provided local to the service/application, which metalink contains a reference to the path to the content in relation to the service/application; providing a service/application with a metalink tag referring to a link to any portal, content etc. which comprises an attribute with a complete URL address of said portal, content etc. and/or providing a service/application with a metalink referring to another service/application if the content to be referred to is associated with an application/service known and given a name in the portal structure, including a reference attribute containing the given name.

The method with advantage includes the steps of; providing a service/application with a number of metainformation tags comprising a number of parameters; adding the metainformation parameters to the metalink parameters; storing the metalink parameters and the metainformation parameters which are common to all the links of the service/application in common in storing means of the portal core per user and per service/application instance; sending the parameters that are different for different links to the requesting end user station. The method preferably includes the steps of; translating the service/application data expressed in the generic markup language into the markup language used by the requesting terminal station. Still further, particularly the portal structure is mobile and supports access by mobile end user stations, e.g. WAP-devices, as well as fixed end user stations, e.g. PC:s. In a particular implementation the generic markup language is XML and the rendering means supports translation into e.g. HTML (HyperText Markup Language) as well as WML (Wireless Markup Language).

The invention also discloses a method of accessing a service/application from an end user station comprising the steps of; accessing a portal structure by selecting a link with parameters to a desired service/application; performing a look-up to find the real address of the service/application in the portal structure; adding the link parameters to the real address; examining if any metainformation parameters are stored relating to the requested service/application instance for the requesting end user; if yes, adding the stored metainformation parameters to the real address with added link parameters; sending the request containing at least link parameters to the service/application; delivering application/service data expressed in a generic markup language (XML) and including possible metalinks and metainformation to the portal core; replacing metalink address information by real address information; storing any received metainformation in storing means associated with the portal core; processing the service/application data in a generic markup language by converting it into the/a format (markup language) used by the end user station.

It is here supposed that applications/services, irrespectively of where they can be found, are expressed as e.g. XML-data, optionally including metalink tags and/or metainformation tags.

The present invention discloses a dynamic conversation selection (based on arbitrary/complex criteria) and it shows a system/method that can handle a plurality of heterogeneous client devices. The inventive concept also allows easy extension for new devices or device types. However, according to the invention the source of specific content (application/service/provider) is determined dynamically, and thus not known to neither users nor content providers themselves. Further, content providers can address own/other content without need to know: Source, means service/applications-specifics. Location and configuration of portal infrastructure especially if content is located inside or outside portal provider infrastructure. In addition, client accesses content without knowledge of physical storage locations.

Still further it provides for device-specific content request adaptation, content request and reply adaptation according to device capabilities, implied security feature, since sensitive parameters are not disclosed to user, while still sent in actual content request towards application/service and particularly user-specific/personalized content presentation. According to the invention locations are not exposed, and hence they can be changed during normal operation.

### BRIEF DESCRIPTION OF THE DRAWINGS

The invention will in the following be further described in a non-limiting manner and with reference to the accompanying drawings in which:

FIG. 1 schematically illustrates an overview of a portal structure according to the invention,

FIG. 2 illustrates the portal structure of FIG. 1 somewhat more in detail,

FIG. 3 very schematically illustrates the procedure when a mobile and a fixed end user station access an application via the portal core,

FIG. 4 illustrates a conceptual division of the presentation arrangement (layer) into a rendering functional layer and a service functional layer,

FIG. 5 illustrates in a simplified manner provision of application data to a mobile end user station through a portal core,

FIG. 6 is a flow diagram illustrating the procedure when an end user station accesses an application according to a first embodiment,

FIG. 7 is a somewhat more detailed flow diagram illustrating end user access to an application, and

FIG. 8 is a further flow diagram illustrating access to an application in an embodiment in which the application is provided with metainformation tags.

### DETAILED DESCRIPTION OF THE INVENTION

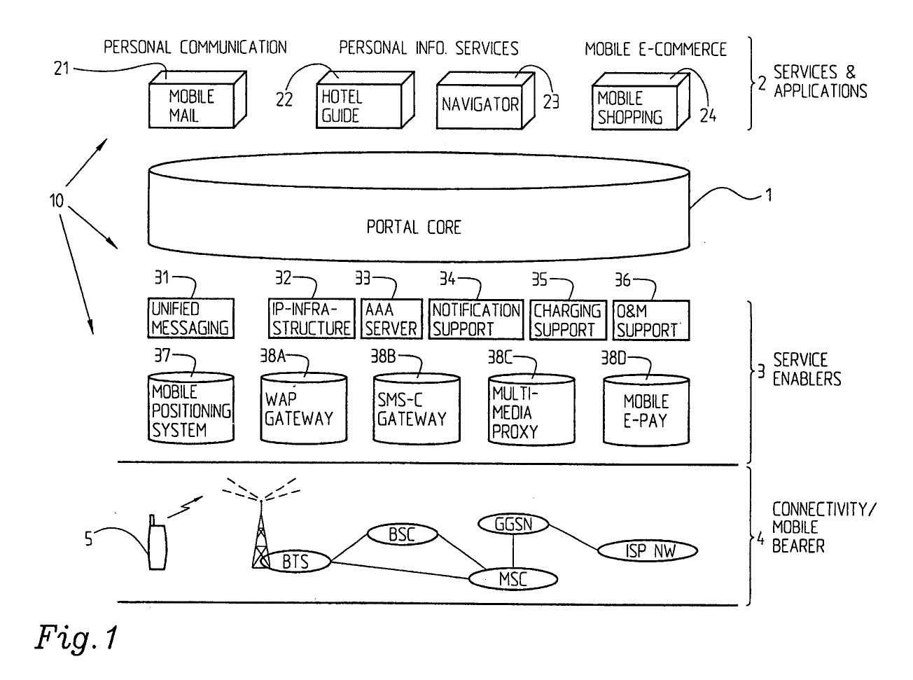

FIG. 1 shows one example on a portal structure 10 according to the invention. The portal structure 10 comprises a portal core 1 handling presentation functionalities, subscription and session management functionalities, a number of services and applications 2, comprising for example personal communication services, personal information services and Mobile E-Commerce services. In FIG. 1 some examples on services and applications are given such as mobile mail, navigation services, hotel guide information, mobile shopping etc. In brief it is not important which kind of services that are provided and the inventive concept is applicable to any kind of service, content and application. When explaining the inventive concept in a more detailed manner, when an end user requests access to a service or an application, any service or application (or content) is meant and can be seen as conceptually included in the portal structure although some of the services and applications actually are located outside the portal structure and are provided by any external service provider.

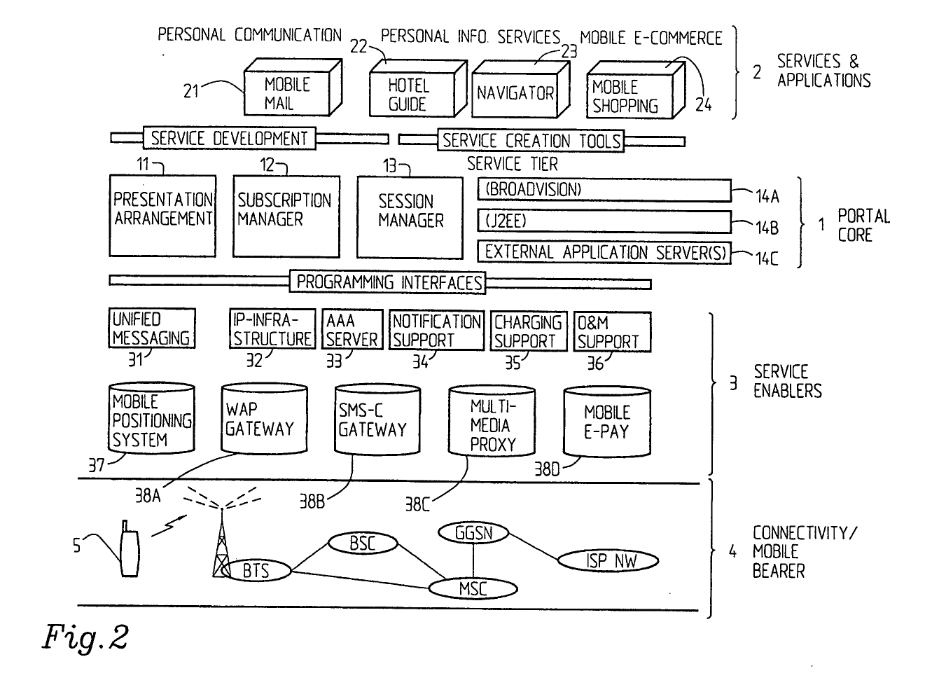

The portal core structure 1 further includes a layer 3 including a number of service enabling means or service enablers 31-37, 38A-38D. The service enablers are among other things involved in authentication and basic services such as gateways and IP infrastructure. In this figure some examples on service enablers are given such as unified messaging 31, IP infrastructure 32, AAA-Server 33 (to be further explained with reference to FIG. 2), notification support 34, charging support 35 and operation and maintenance support 36. Further service enablers are mobile positioning system 37, WAP gateway 38A, SMS-C gateway 38B, multimedia proxy 38C, mobile E-pay 38D etc. It should be clear that some of these service enablers are more or less mandatory whereas others are optional. This will be further discussed with reference to FIG. 2.

The portal structure is here also seen as including a connectivity or a (mobile) bearer layer comprising the mobile base stations and switching nodes, such as BTS (Base Transceiver Station), BSC (Base Station Controller), MSC (Mobile Switching Center) nodes etc. Which the nodes are, depends on which mobile network access is provided over, e.g. GSM. For GPRS or UMTS corresponding nodes are included in this layer; for example GGSN (Gateway GPRS Support Node). Whichever is the network, the network is the data bearer for the portal for access of mobile devices such as WAP-devices (Wireless Application Protocol). In

FIG. 1 it is supposed that the accessing end user station comprises a WAP-telephone 5.

One example on such a portal structure is the Ericsson WISE™ Portal.

In FIG. 2 the portal structure is illustrated somewhat more in detail, particularly as far as the portal core is concerned. The services and applications mobile mail 21, hotel guide 22, navigation 23 and mobile shopping 24 are the same as in FIG. 1. Internal applications or services can be seen as applications leveraging the service enablers and connectivity layers to add application specific values to mobile Internet applications of various categories, for example mobile services, personal communications as unified messaging or mail services and personal information services. The information may be retrieved by the user through searches, but the information may also be provided to the end user by means of the push technology. This is open to end user customization.

It is here supposed that the portal supports access by mobile end user stations, such as WAP-telephones 5 over a mobile network as discussed with reference to FIG. 1. Therefore nodes or components of the relevant mobile network have to be provided in the mobile network connectivity and data bearer layer. In this embodiment a component denoted ISP network, Internet Service Provider network is disclosed. This is an optional component which may be included or not.

In the layer comprising the service enablers 3 some types of service enablers are mandatory whereas other are not. Some of the service enablers are important components for providing mobile Internet functionalities. Some of the service enablers are seen as one part of the interface components between Internet and the mobile network. One component is here denoted IP infrastructure 32. An optional service enabler comprises the notification support 34 which generally is an optional component enabling applications to send out filtered notifications to end users using the SMS (Short Message Service) channel, but it may also be adapted to include other channels supporting WAP technology and 3G (3GPP) technology. Charging support enabler 35 may be provided to allow for flexibly choosing charging events. Another service enabler 36 relates to operation and maintenance support and generally it is a mandatory component. A service enabler WAP gateway 38A relates to an optional service enabler WAP gateway/proxy forming the access point between the wireless world and the Internet world. It supports mobile clients accessing the WAP gateway/proxy using GSM circuit switched data or WAP over SMS (SMS over MAP (Mobile Application Protocol)). The client uses a WAP enabled browser in the mobile device to connect to the WEB-server where the desired WAP application resides. Another service enabler, mobile positioning system, 37 is an optional component allowing sending the position of a user to the application requesting it. Another service enabler is here a multimedia proxy 38C responsible for transmitting multimedia data over GPRS or UMTS. This however is an optional service enabling means. Also SMS-C (center) 38B is an optional component responsible for sending or receiving, storing and forwarding short messages between mobile stations and servers. Proprietary protocols are used for communication with applications. Mobile E-pay 38D is a component offering the basic functionality for Mobile E-Commerce and it is an optional component. Finally, cf. FIG. 1, AAA-Server is a service enabling component relating to authentication, authorization and accounting. These functionalities may be provided in other manners but they may also be integrated in a functionality server for example enabling traffic based charging and period charging. Such a component, either if it is split up into different components or comprises one component which is common for a number of functionalities, is mandatory.

However, it should be clear that FIG. 1, FIG. 2 merely show examples on service enabling means that may be provided in a service enabling layer 3. At least some of the illustrated service enablers may be excluded, others may be included etc.

The portal core, or the portal core layer, handles, as referred to above, presentation, subscription and session management and service tiers comprising a number of internal (and external) application servers. The core 1 comprises a presentation arrangement 11 which enables mobile portal presentation on multiple devices using multiple protocols. It may e.g. be XML driven (or more generally driven by a generic markup language). In one implementation it is a Java™ and XML driven multimarkup language capable presentation module.

The presentation arrangement 11 comprises a rendering means or a rendering engine which in one implementation uses XML/XSLT technologies to ensure that information presented by services within the portal is displayed in a standardized way regardless of which end user station an end user uses when accessing the portal structure. Through the use of a generic markup language, for example XML/XSLT, the portal is able to offer a unified “look and feel” of content presented within the portal presentation space, i.e. it ensures that the use of for example colors, fronts and background images are enforced for all services displaying their information through the portal. The patent application titled “An Arrangement and a Method for Presentation Customization in a Portal Structure”, which is a patent application filed on the same date and by the same applicant as the present application, and the content of which herewith is incorporated herein by reference, relates to user customization in a portal structure as described herein, and particularly it is concerned with presentation issues, “look and feel”. Such a functionality may, in an advantageous implementation, be included in the portal structure as claimed in the present invention.

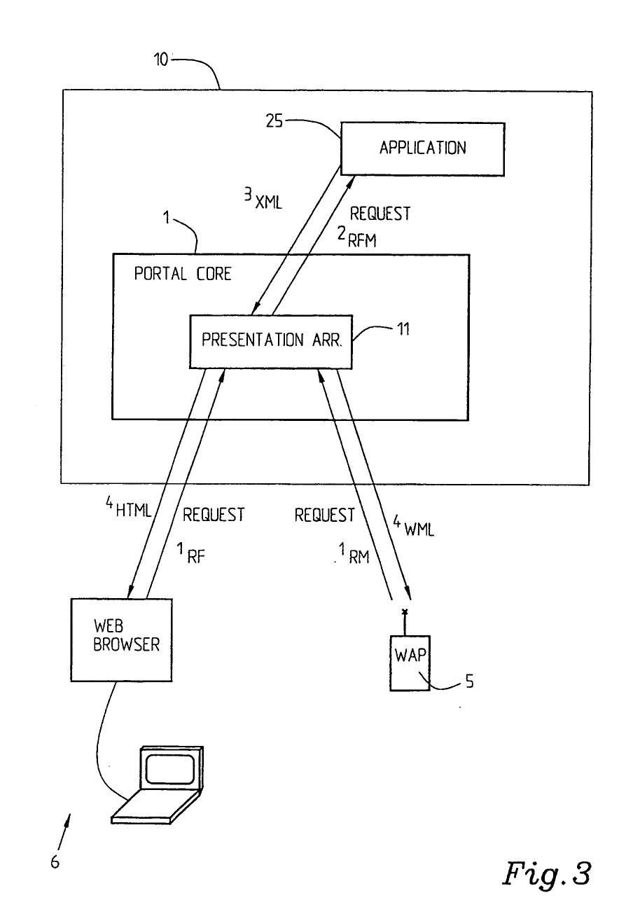

The functionalities within the portal core 1 and of the presentation arrangement 11 in particular will be further described with reference to FIGS. 3 and 4 and 5.

The portal core 1 also includes the subscription manager 12. In one implementation subscription manager component information is stored in an LDAP (Lightweight Directory Access Protocol) directory and it is managed by the service called subscription manager. The subscription manager includes functions for the operator to create, maintain and delete subscriber information in the subscriber database. It also enables the end user of the system to register with the services in the system. In a particular implementation a self-registration and self-service concept is supported in order to minimize costs by minimizing the workload on a customer care center. Information about available services may also be kept in the directory referred to above and handled by the subscription manager. As a new service is entered into the directory, it will immediately be available for subscription by the end users. In the directory end users can be grouped so as to make new services available only to defined sets of end users. The subscription manager 12 can be interfaced with an existing customer care system through the Application Programming Interface (API) it uses.

The session manager 13 is a general mechanism that can be used by applications and services. It comprises an interface to a subsystem for keeping track of all visitors to the portal and to provide the profile information of the visitors. When an end user enters the system/application a session-id entity is allocated and it is stored for that particular end user until logging out of the service or when the end user has been idle for a preset period of time. When a participating application starts, it first checks if there is an active session-id for a particular user and if there is, it would be able to resume from where the session was broken. The Swedish patent application “An Arrangement and a Method Relating to Session Management in a Portal Structure”, which is filed on the same date and by the same applicant as the present patent application is herewith incorporated herein by reference. It discloses an advantageous way of unifying session management of portal sessions and sessions of external (externally session managed) services/applications. This concept may also be implemented on a portal structure as disclosed in this document.

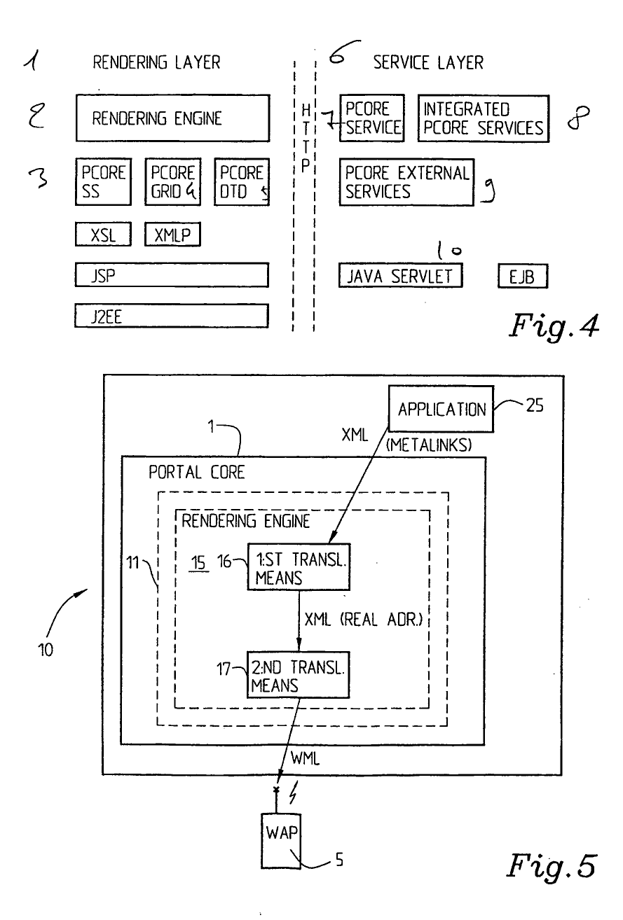

Finally the portal core structure 1 here comprises two “internal” application servers 14A, 14B and one or more external application server 14C. The external application server 14C contains links to external application servers running existing services. In one implementation the service tier comprises three classes of services, of which a first is developed in compliance with the portal core specifications implemented using the portal core environment. The second service class relates to services which not necessarily are implemented in the portal core environment, such as for example an external e-mail system running on a non-portal core environment adapted to present itself through the portal core presentation. The third service class relates to external services which do not comply with the portal core service development or presentation architectures. This will be further explained with reference to FIG. 4. FIGS. 1 and 2 above describe one example of a portal core structure in which the inventive concept can be implemented.

The inventive concept will now be further described, first with reference to FIG. 3, which shows an implementation in which it is supposed that the portal structure supports access by mobile as well as fixed end user stations.

FIG. 3 shows for example the portal core structure 10 of FIG. 1 or 2 but only including the components of main interest for the functioning of the present invention. In the figure it is illustrated how a fixed end user station 6 via WEB-browser sends a request 1_{RF} to the presentation arrangement 11 of the portal core 1 for an application. The figure also illustrates how mobile end user station WAP 5 sends a request 1_{RM} to the presentation arrangement 11. In both cases the presentation arrangement 11 of the portal core 1 forwards the request 2_{RFM} to the application 25 e.g. using HTTP (Hypertext Transfer Protocol). As an alternative to HTTP may any other appropriate protocol be used, e.g. RMI (Remote Method Invocation). The application may be an application which is provided within the portal core but it may also be an external application. Although the application is illustrated in this figure as residing within the portal core structure, the functioning would be the same if it was provided externally and application 25 is thus conceptionally an application which is either internal or external to the portal core structure. It is however presupposed that the application uses or generates a generic markup language, in this embodiment XML. Of course some other generic markup language with properties similar to those of XML may be used, although in the following it will be referred to the XML language, since this relates to a particularly advantageous implementation.

According to the invention one or more metalink tags may be introduced to the application XML data for providing references to other applications, services, content within or outside the application itself. The applications can then produce XML link data independently of the location of the portal or of any other services/applications. The applications do not need to know their own or other applications public (real) addresses. The application 25 then returns XML data 3_{XML}, which may include one or more metalink tags, to the presentation arrangement 11. The presentation arrangement includes a rendering means (not shown in this Fig.) with first translating means for translating the received metalink(s) (if there are any included in the XML data) into real public addresses for the application(s)/service(s)/content as indicated by the metalink(s). Thus, the translation of the metalinks into real public addresses for the applications will be done in the portal core instead of by the applications themselves. Thus, when, or if, application 25 in this case, delivers XML data containing metalinks, the rendering process within the rendering means, i.e. the first translating means of the rendering means, will filter out the metalinks and replace them with the correct addresses to the respective applications, services etc. The metalinks may be defined, as all XML data, in a Document Type Definition language (DTD) as e.g.:

<!ELEMENT metalink (param*)>
<!ATTLIST metalink
type (self | local | absolute | application )
#REQUIRED

| | | |
|---|---|---|
| ref | CDATA | #MPLIED |
| url | CDATA | #MPLIED> |

<!ELEMENT param EMPTY>
<!ATTLIST param

| | | |
|---|---|---|
| name | CDATA | #REQUIRED |
| value | CDATA | #REQUIRED> |

A typical metalink tag in the XML data will look like:
<metalink type =“self”>
<param name=“cmd” value=“hello” />
</metalink>

When the first translating means of the rendering process/means detects the above metalink tag, it will look up the address for the current application and insert the real address in the “url” attribute. The parameters in the “param” tags may also be added to the address. The url attribute can be used by the application generating the metalink, but it will be overwritten by the rendering process. This makes it easy to test the applications and the generated XML data without needing to process the XML data through the portal structure. The application can in the url attribute put a temporary url to itself for testing, but when the application is tested through the portal, it will work without changing the code.

After the metalinks have been processed and translated by the first translating means (not shown in this Fig.), the subsequent step of the rendering process will take place in the second translating means used to process the XML data with a Transformation Stylesheet (XSL transformation), to produce an output appropriate for the end user terminal 5,6, i.e. for end user terminal 5 which is mobile the response 4_{WML} will be provided in the WML (Wireless Markup Language) whereas to the fixed end user station 6 the response _{4HTML} will be expressed in HTML (Hyper Text Markup Language).

The transformation will thus recognize the metalinks and extract the url attribute and format, i.e. in the markup language as it is expected by the respective end user stations. Continuous navigation within the portal is then enabled and the associations between available content can be stored in a device (end user station) independent format irrespectively of whether the content that it accessed, i.e. the service of the application, resides within the portal or is externally provided. Then dynamic issues like access control can be also be handled.

Different types of metalinks can be defined. In one particular embodiment four different types of metalinks are defined which here are denoted “self”, “local”, “absolute” and “application”. A metalink of type “self” references the current application that has generated the XML data, metalink type denoted “local” references resources, for example images, which are local to the application. The “ref” attribute must then contain the relative path, relative to the application, to the resource. The metalink type denoted “absolute” is a link to any public or private portal WEB page, resource or application. The “ref” attribute must contain the complete URL to such a resource. Finally the metalink type denoted “application” refers to an application known by the portal and which has been defined and given a name by the portal. The reference attribute should in this case contain the name of the application as defined by the portal. Metalinks of type “self” and “application” are always processed through the presentation layer whereas the “local” and “absolute” types need not. It is also possible to use one metalink type relating to both metalinks of “local” and “absolute” type.

It is of course also possible to define other types of metalinks. The denotations are also merely examples, any denotations may be used.

In the following the portal core, and specifically the presentation arrangement, or the presentation layer, will be more thoroughly described, particularly with reference to FIG. 4. The service tier, cf. FIG. 2, in one advantageous implementation comprises three service classes. The service class portal core service (pcoreservice) complies with the specifications of the portal core and it is used to leverage the portal core characteristics. In one implementation the services are implemented using the J2EE IBM WEBSphere Environment (an application server used to develop programmatic services involving logic, algorithms etc.). Such services generally have three or four tier architectures deploying JSP (Java Server Pages) on the front end, Java servlets and Enterprise Java Beans (EJB) in the middle layer and various entities on the back end. The second service class are the integrated portal core services (integrated pcore services) which leverage pcore presentation services but which are not necessarily implemented in the portal core J2EE environment, e.g. an external e-mail system running on a non-portal core environment but adapted to present itself through the portal core presentation. The third service class pcore external services neither comply with the portal core service development nor with the presentation architectures but the services have to be triggered to or brokered by the portal core.

In one implementation there are two types of service options available within the service layer. One may consist of services provided by Broadvision (Corba; for creating optimized rule based and personalized services connected to commerce and retail), and optimized for content delivery by a matching engine operating on content, profile and business rules. The other service type relates to programmatic services for example requiring algorithms, logic etc. which are not easily built in an optimized content delivery system. If these services are of pcore service class, then they may be industrialized for IBM WEBSphere J2EE environment and if they are of integrated services class and running in an external service server, they are adapted to the portal core presentation.

A service needs specifications including elements on the rendering functionality of the presentation layer as well as relating to the service layer functionality, i.e. schemes and logic. The portal core presentation architecture may, as referred to above, in one advantageous embodiment implement the J2EE architecture for the mechanisms of creating and employing services in specific elements or for defining services. However, the invention is not limited to a portal structure using J2EE and Broadvision; these are merely examples.

The presentation layer is conceptually split-up into two tiers, one rendering layer residing in the portal core itself and a service layer available to any service that wants to presents its content through the portal core presentation structure. The rendering layer in one advantageous implementation uses XML/XSLT technologies. Thereby it is also ensured that information presented by services within the portal can be displayed in a standardized way irrespectively of which is the end user station, i.e. irrespectively of which kind of end user station the end user uses when accessing the portal. Through the use of XML/XSLT a unified “look and feel” of content may be presented within the presentation space.

If XML is used as a generic markup language, a service produces an output in the form of an XML document formatted using structure information from a pcore DTD. The XML output from the service is then used to feed the presentation engine of the presentation arrangement. The presentation engine uses pcore SS and pcore grid information associated with the pcore DTD of the XML document supplied by the service to generate the desired interface. Services which do not produce XML from a pcore DTD are particularly also able to present themselves through the presentation services.

As referred to earlier the portal structure is advantageously able to handle different devices such as WAP-phones and broadband devices such as PCs. A portal core structure platform and the logic in it are particularly totally separated from the presentation layer functionality, which makes it very easy to implement support for all different types of clients, even voice and speech synthesizers. By using for example XML/XSL, it is very easy to implement support for instance for a new type of WAP-display size. It is also possible to adapt the rendering process to various WEB-devices, existing and future hand-held devices, voice browsing and interactive TV.

In one particular implementation the WEB-interface is composed of square elements also denoted bricks. A brick is a container of a service, a picture or an application. Using such bricks or containers, it is possible to customize the portal. A brick is thus an application created to be used inside the portal structure, which has a link to the application. The application has to provide display information to the portal when it wishes to render the brick. Advantageously a brick can appear in more than one format. The disposition of the bricks or containers represent a so called brick interface. In order to enable easy navigation the WAP-interface will be structured in the same way. In the WEB-interface the user is presented with a list of available bricks. Each brick contains an application, service or a background picture that can be included in the users built WEB-site. A brick can also be a pre-configured service from an external company or provider. A Brick-grid is a non-visual representation of a customized portal. Depending on device, the brick grid is represented in a way that is most suitable for the device in use. The grid can be designed in many ways as well as the bricks may be presented and organized in different ways, for example with tags. The brick grid is stored in a generic format and it is device/end user station independent.

Preferably the end user authenticates himself towards the portal with a one time login which will give the end user access to all the functionality within the portal. Any authentication towards connected or to external content or service providers is handled by the platform security system. Advantageously each application or service within the portal can be personalized to fit the needs of the end user and each application can be personalized for different devices. This is particularly advantageous when an end user wants to limit the amount of data sent to another end user station with limited capacity to present larger amounts of data, e.g. a WAP-phone. It is possible to select one application more than once and to give each of the different instances its own personalization.

The inventive concept will be more thoroughly described with reference to FIG. 5. FIG. 5 is an illustration similar to that of FIG. 3 but illustrating somewhat more in detail an application generating XML data with possible metalinks and providing the XML data to the rendering engine 15 of the presentation layer 11 of the portal core 1 having sent a request to the application 25. In the first translating means 16, which actually forms part of the rendering process (or comprises a separate process within the rendering engine) metalinks are translated to real addresses of the application/services/content referred to by the respective metalink. XML data with the real address is then further processed by the rendering means in a separate process 17 or within the common process constituting the first 16 and second 17 translating means to render the XML data and output it in a format understandable to the end user station, i.e. translating it into the markup language understood by the end user station. In FIG. 5 it is supposed that the end user station is. a WAP-phone 5. In that case, in this implementation, the XML data is translated to WML.

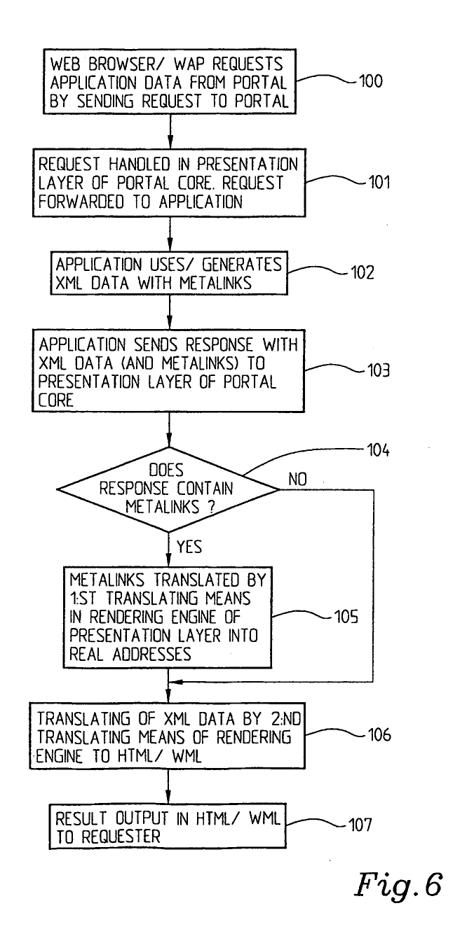

The procedure when an end user station, e.g. via a WEB-browser or a WAP-phone requests application data from a portal is described with reference to the flow diagram in FIG. 6. It is supposed that a WEB-browser/WAP-device requests application data from the portal by sending a request to the portal, 100. The request is thereupon handled in the presentation arrangement (layer) of the portal core and the request is forwarded to the requested application, 101. The application then uses/generates XML data (in this embodiment) with or without metalinks depending on whether it wants to refer to other applications or services or not, 102.

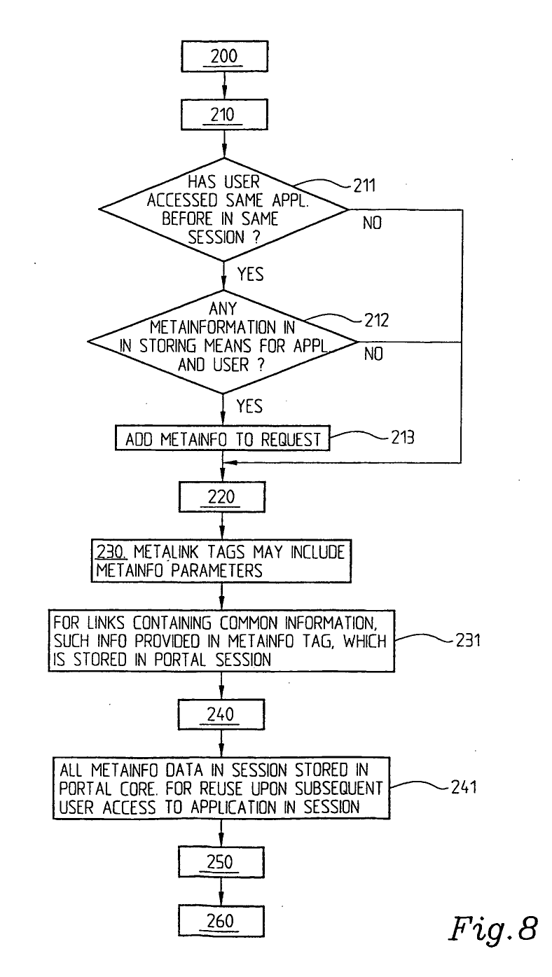

Subsequently the application sends a response with the XML data and possible metalinks and possibly also metainformation tags to the presentation layer of the portal core, 103. An embodiment in which also metainformation tags are introduced to the XML-data is more specifically illustrated in FIG. 8, therefore this is not indicated in FIG. 6, but merely briefly referred to. In the portal core it is examined whether the response contains any metalinks, 104. (If the concept of metainformation tags is implemented, it is here examined if any metainformation tags are contained in the response. If yes, the metainformation is stored in the portal, e.g. in a portal session created for the requesting end user relating to the requested service/application, where it is stored for a given period of time, e.g. until the session has been idle for a preset time interval.) If the response contains metalinks, yes, the metalinks are translated by first translating means in the rendering engine or the rendering means in the presentation arrangement (layer) into real addresses, 105. Thereupon the translation of the XML data is performed by the second translating means of the rendering engine, e.g. to HTML or WML, 106. In case there are no metalinks, cf. 104 above, step 105 is redundant and the XML data is directly translated into HTML or WML (for example). Subsequently the result is output in HTML or WML to the requester depending on which markup language that is used by the end user station, 107. It should be clear that, when referring to first and second translating means it is actually referred to processes within the presentation arrangement or specifically within the rendering engine.

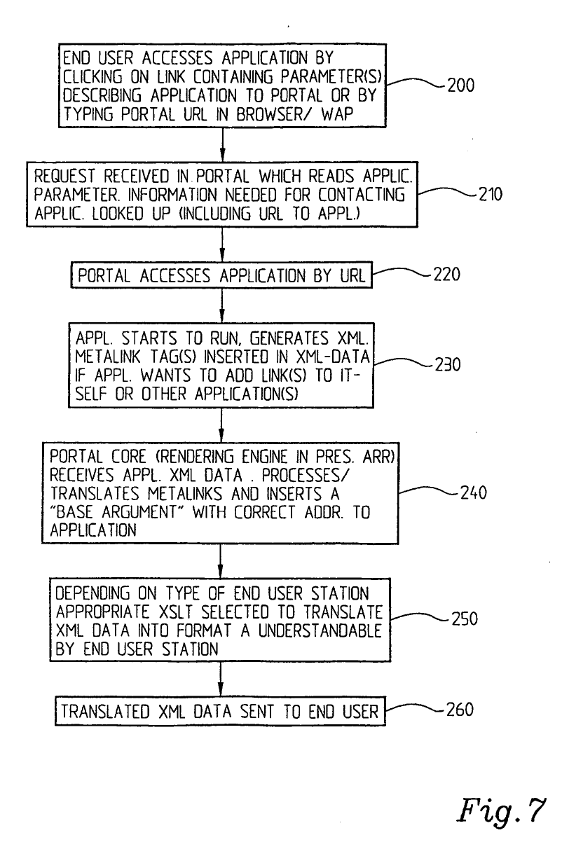

The inventive procedure will now be described somewhat more in detail with reference to FIG. 7. When an end user accesses the portal by accessing an application, the end user in one implementation clicks on a link containing parameters describing the application, 200. Alternatively the portal URL address can be typed in the browser or on the WAP-device. The link has to contain a parameter describing which application the user wants to access. As an example, if the user wants to access an application denoted “bricks”, the user could type in the URL:
http://www.pcore.net?app=bricks

When the portal structure has received the request and read the application parameters, it looks for the information, e.g. in application managing means, which is needed to contact the application. This information includes the URL that is required for connection to the application, 210. The portal then accesses the application by the URL address, 220. The application, when having been accessed by the portal structure, starts to run and produce XML. If the application wants to add links back to itself or to some other application etc., it introduces metalink tags into the XML data as discussed more thoroughly above, 230. (In one implementation may also metainformation tags be introduced into the XML data by the application. Metainformation tags may also be introduced regardless of whether any metalink tags are introduced.)

As an example, the application “bricks” as referred to above, might want to link back to itself by producing the metalink:
<metalink type=“self” />

The portal will then replace this with:

<metalink type=“self” base=“http://www.pcore.net”><
<param name=“app” value=“bricks” />
</metalink>

Then the XML data, with or without one or more metalink tags, is returned to the portal core, or more particularly to the presentation layer. The portal core, i.e. the rendering means or the rendering engine of the presentation arrangement receives the application XML data and processes all metalinks (if any) and inserts a base argument with the correct address to the application, 240.

Depending on type of end user station an appropriate XSLT (XSL transformation sheet) is used for the rendering of the XML data into a format (other markup language) that the end user station can understand. The XML data is then rendered (translated) into the appropriate language, 250, and finally it is sent back to the end user, 260. In the rendering process all the metalink tags are translated to links in the target language.

In a particularly advantageous implementation a service or an application (although it is sometimes only referred to as an application in this document, it should be clear that also a service, or a content could be meant) may include or generate one or more metainformation tags in the XML data. The DTD for the metainformation or metainfo, could be, if the param (parameter) is the same as the metalink:
<!ELEMENT metainfo (param*)>

For example a metainfo tag may look like:

```
<metainfo>
    <param name=“externalsessionid” value=“4711” />
    <param name=“userid” value=“jan” />
</metainfo>
```

All the parameters in a metainformation tag will then, by the rendering process, be added to all the metalink parameters, particularly of type “self” or “application” as referred to above.

All parameters that are common to all the links in the application will then be defined in one place and they are advantageously stored by storing means in or associated with the portal core. In that way the stored parameters (common to all the links of an application) can then be sent to the application when the same end user accesses the application subsequently (during the same session). The parameters are thus stored per end user and per application instance and different application instances can thus have different global parameters. An advantage of such an implementation is that the parameter list and thereby the address (URLs) for applications that are sent to an end user can be much shorter. This is particularly of importance if an end user accesses the portal using a mobile end user station such as a WAP-device. Only the parameters that are different for different links have to be sent to the end user station. The concept of introducing metainformation tags may also be implemented irrespectively of whether the concept of metalink tags is implemented.

For an implementation in which provision of metainformation tags is implemented, a user accesses an application in the portal by clicking a link in e.g. a browser. As above, the link contains parameters to some application. In the portal the real addresses to the application are looked up and the parameters are added. Subsequently the portal checks to see if there is any metainformation stored for the particular application instance and for the particular end user. If yes, the stored metainformation parameters are also added to the address. The request is then sent to the application (containing parameters to the application and metainformation parameters if there were any). The application then delivers XML data back to the portal core. It contains, or may contain, metalinks and metainformation. In the portal the URL in the metalinks is translated/replaced by the URL to the portal. The metainformation data (if any) are stored for possible subsequent accesses by the same end user during the session. The application XML data is then rendered or translated, i.e. the rendering means processes the complete XML document including possible metalinks, to produce an output format understandable by the end user station.

An example of a flow describing an embodiment implementing introduction of metainformation tags will be more thoroughly described with reference to FIG. 8. The first two steps are substantially identical to the two first steps as described with reference to blocks 200 and 210 of FIG. 7. Moreover, in this implementation it is examined if the user has accessed the same application before during same session, 211. If yes, it is checked if there is any metainformation stored in the storing means for that application and end user, 212. If yes, the stored metainformation is added to the request to the application, 213. The subsequent step corresponds to step 220 of FIG. 7 with the difference that also metainformation has been added to the request. In the subsequent step, substantially corresponding to step 230 of FIG. 7, if there are metainformation parameters, they are contained in the metalink tags (such parameters will be sent back to the application if the end user clicks the link at a later stage). If all or many of the links contain the same information, for example an external session id used by the application, this information could be added to all metalinks. But in order to save space in the XML document, all these common parameters can be removed from all metalinks and replaced by one metainformation tag containing all said parameters. This metainformation will be stored in the portal session and sent back to the application the next time it is accessed by the end user during the same session. This also reduces the URL length in the links since the data is stored in the portal instead of being sent to the user, 231. Subsequently the step corresponding to block 240 of FIG. 7 is performed, i.e. the portal receives the XML data with possible metalinks and metainformation tags.

All metainformation data (if any), in the session is stored in the storing means in or associated with the portal core such that it can be sent back to the application the next time it is accessed. For each application a namespace is created in the session where the metainformation is stored. The portal will also add a namespace parameter to all metalinks, which then will be sent back to the user in the links. On a subsequent access by the same end user to the same application, the portal will use this namespace argument to do the lookup in the session. The session id is also added to the metalink as a parameter so that the portal can find the correct session the next time. After this transformations the metalink might look like:

```
<metalink type=“self” base=“http://www.pcore.net”>
    <param name=“app” value=“bricks” />
    <param name=“session_id” value=“s123” />
    <param name=“namespace” value=“nsll” />
</metalink>
```

For convenience all the params are added togheter with the base argument into an URL argument as in HTML, as will be described below.

Subsequently follow the steps corresponding to blocks 250, 260 of FIG. 7.

In the rendering process all metalink tags are translated to links in the target language and the above metalink could for example be translated into (using HTML):

<A HREF=“http://www.pcore.net?app=bricks&session_id=123&
namespace=nsll>Click</A>

The above flow may e.g. be examplified as follows: If the link clicked to access the portal is a link generated via a metalink, it might look like:

http://www.pcore.net?app=bricks&session_id=s123&namespace=nsll&
applicationparameter=Hello

The portal will then first lookup the application URL as above, and for bricks it might be:
http://applications.pcore-net/bricks

and all the other parameters in the request will be added, thus providing:

http://applications.pcore.net/bricks?app=bricks&session_id=s123&
namespace=nsll&applicationparameter=Hello

Then a check is performed in the session to see if there is any metainformation stored. If that is the case, all metainformation parameters are added and the result could then be:

http://applications.pcore.net/bricks?app=bricks&session_id=s123?
namespace=nsll&applicationparameter=Hello&external_session_id_{—}
123

It is an advantage of the invention that it provides for a generic framework for seamless navigation between applications inside the portal. The links between any applications can be written independently of the portal or location of the applications and independently also of the type of end user station.

If the concept of metainformation is implemented in addition thereto, it is very advantageous that the links and parameters that have to be sent to the end stations are considerably reduced since common parameters are stored in the portal.

The concept of using metainformation may also be implemented irrespectively of whether the concept of metalink tags is implemented. Then, however, it may be implemented with other links, e.g. XLink or links similar to metalinks.

It should be clear that the invention is not limited to the specifically illustrated embodiments but that it can be varied in a number of ways within the scope of the appended claims.

1-32. (canceled)

33. A portal for providing end user stations with access to services/applications, comprising:
a portal core having a number of service enabling means;
a connectivity layer via which end user station access is provided;
a number of services/applications, wherein the services/applications are represented in a generic markup language, the portal core using said generic markup language for storing at least application/service data information and for communication with said services/applications; and
a presentation arrangement for communication with said applications/services and said end user stations, each service/application represented by generic data in the generic markup language optionally being provided with a number of metalink tags, such that each service/application is able to generate generic link data in the generic markup language irrespectively of the location of the portal and of other applications, wherein the presentation arrangement comprises first translating means for replacing such metalinks with real (public) addresses of the services/applications, such that continuous navigation is enabled for end users irrespectively of the location of accessed services/applications.

34. A portal according to claim 33, wherein the portal core comprises rendering means comprising said first translating means.

35. A portal according to claim 34, wherein the presentation arrangement comprises said rendering means.

36. A portal according to claim 34, wherein the rendering means comprises second translating means for translating/rendering service/application data in the generic markup language into a markup language used by the end user station.

37. A portal according to claim 33, wherein the portal core further comprises session handling means for user session management.

38. A portal according to claim 37, wherein said session handling means are separate from, but in communication with, said rendering means.

39. A portal according to claim 33, wherein a number of types of metalinks are defined depending on the location of the linked service/application in relation to the service/application accessed by the portal core.

40. A portal according to claim 39, wherein a first type of metalink (“self”) is defined which refers to the service/application that itself has generated the data, as represented in the generic markup language.

41. A portal according to claim 39, wherein a second type of metalink (“local”) is defined which refers to resources which are local to the current service/application and in that it includes information about the path to the resource in relation to the current service/application.

42. A portal structure according to claim 39, wherein a third type of metalink (“absolute”) is defined which comprises a link to any public or private portal, web-page, resource, application or content and in that it contains a complete URL-address to such portal, resource etc.

43. A portal according to claim 39, wherein a fourth type of metalink (“application”) is defined which refers to an application which is defined in the portal under a given name and in that the metalink contains information about said name.

44. A portal according to claim 33, wherein data representing services/applications expressed in the generic markup language and metalinks are defined in a Document Type Definition Language with an URL-attribute.

45. A portal according to claim 33, wherein said portal supports access by mobile end user stations.

46. A portal according to claim 45, wherein said portal supports access by fixed end user stations, e.g. PC:s, wherein fixed end user stations use a markup language different from the markup language(s) used by mobile end user stations.

47. A portal according to claim 33, wherein a service/application optionally is provided with a number of metainformation tags and in that the rendering means adds the parameters of said metainformation tag(s) to all metalink parameters at least for some type(s) of metalinks.

48. A portal according to claim 47, wherein an application/service comprises a number of links to other applications/services, that metainformation tags optionally can be added to “self” or “application” type metalinks and in that all parameters common to all the links of an application are stored in the portal core per end user and per application instance.

49. A portal according to claim 45, wherein said portal supports access to services/applications by mobile end user stations, e.g. WAP-devices over a mobile communications network with access nodes in the connecting layer and fixed stations WEB-devices, e.g. broadband devices such as PC:s.

50. A portal according to claim 33, wherein the generic markup language is XML.

51. A portal according to claim 50, wherein the XML data and the metalinks are defined in a Document Type Definition language (DTD) and in that a metalink tag in XML comprises information about metalink type, addressing attributes containing service/application location information depending on metalink type and a number of parameters.

52. A portal according to claim 33, wherein the second translating means translates XML data by performing a transformation (XSL) to an output format, i.e. a markup language appropriate for an accessing end user station, e.g. HTML for a fixed end user station or WML for a mobile end user station.

53. A portal for providing end user stations with access to services/applications comprising:
a portal core;
a number of service enabling means;
a connecting and data bearer layer via which end user access is provided; and
a number of services/applications, wherein the portal core is XML-based using XML as a markup language for storing data as XML-data and for communication with services/applications, and wherein the portal core comprises means handling presentation on end user stations, that the services/applications generate XML-data, a service/application generating XML-data optionally being provided with metalink tag(s) for referring to other application(s)/service(s)/content, such that each service/application is able to generate XML link data independently of which is the location of the portal core and of other services/applications, and wherein the portal core comprises first translating means for replacing metalinks with real addresses of services/applications, such that continuous navigation is provided for end users independently of the location of accessed services/applications.

54. A portal according to claim 53, wherein it supports end user access by mobile as well as fixed end user stations, e.g. WAP-devices and broadband devices such as PC:s, interactive TV etc.

55. A portal for providing end user access to services/applications comprising:
a functional services/applications layer;
a user access layer; and
an intermediate communication layer for communication with services/applications and end user access means (stations), wherein the intermediate communication layer comprises a presentation arrangement with rendering means and session handling means receiving requests for services/applications by end user stations, forwarding such requests to the requested service/application, and for receiving XML-data information representing requested services/applications, that the services/applications may be provided with metalink tag(s) for referring to other applications/services/contents, said rendering means comprising translating means for replacing metalinks with corresponding real address information relating to services/applications and means for translating such XML-data information to a format usable by the requesting end user station.

56. A method for providing an end user station with access to services/applications via a portal comprising a portal core, a plurality of services/applications and end user connectivity means, comprising the steps of:
providing an application/service in a generic markup language with a number of metalink tags for referring to other application(s)/service(s)/content and/or with a number of metainformation tags;
receiving in the portal core a request for a service/application from an end user station in the end user language format;
forwarding the request to the requested service/application;
returning data relating to the requested service/application as represented by the generic markup language to the portal core with possible metalink tags and/or metainformation tags;
translating the metalinks defined by the tags to real addresses of the links in the portal core and/or storing the metainformation of the metainformation tags into a portal session for the end user relating to the requested service/application; and
providing the service/application to the end user station in a format appropriate for the end user station.

57. A method according to claim 56, wherein the portal core comprises rendering means, said rendering means performing the steps of:
detecting if data of a service/application delivered in the generic markup language contains any metalinks; and
if yes, processing said metalink(s) and replacing it with the real address of the service/application referred to.

58. A method according to claim 56, further comprising the step of providing services/applications with metalinks of given types depending on where the content of a service/application, to which there should be a link, is located.

59. A method according to claim 58, further comprising the steps of:
providing an application/service with a metalink tag referring to the application itself for content provided by the application/service itself;
providing a service/application with a metalink tag referring to local content for content provided local to the service/application, which metalink contains a reference to the path to the content relative to the service/application;
providing a service/application with a metalink tag referring to any portal, content etc which comprises an attribute with the complete URL address of said portal, content etc.; and
providing a service/application with a metalink tag referring to another service/application if said other application/service is known and given a name by the portal, including a reference attribute containing the given name.

60. A method according to claim 56, further comprising the steps of:
providing a service/an application with a metainformation tag comprising a number of parameters;
adding the metainformation parameters to the metalink parameters;
storing the metalink parameters and the metainformation parameters common to all the links of the service/application parameters in common in storing means in or associated with the portal core per user and per service/application instance; and
sending the parameters that are different for different links to the requesting user terminal.

61. A method according to claims 56, further comprising the step of translating the service/application data as expressed in the generic markup language into the/a markup language used by the requesting terminal station.

62. A method according to claim 56, wherein the portal is mobile and supports access by mobile end user stations, e.g. WAP-devices as well as fixed end user stations, e.g. PC:s.

63. A method according to claim 56, wherein the generic markup language is XML and in that the rendering means supports translation into e.g. HTML as well as WML.

64. A method of accessing a service/application from an end user station comprising the steps of:
accessing a portal by selecting a link with parameters to a desired service/application;
performing a look-up to find the real address of the service/application in the portal;
adding the link parameters to the real address;
examining if any metainformation parameters are stored relating to the requested service/application instance for the requesting end user, if yes, adding the stored metainformation parameters to the real address with added link parameters;
sending the request containing at least link parameters to the service/application;
delivering service/application data expressed in a generic markup language (XML) including metalink tags and/or metainformation tags to the portal core;
replacing metalink address information by real address information and/or;
storing received metainformation in storing means associated with the portal core; and
processing the service/application data in a generic markup language and converting it to the format used by the end user station.
